(19) United States
(12) Patent Application Publication
(10) Pub. No.: US 2015/0228242 A1
(43) Pub. Date: Aug. 13, 2015

(54) DISPLAY DEVICE, METHOD OF MANUFACTURING THE DISPLAY DEVICE, AND MOTHER SUBSTRATE ASSEMBLY

(71) Applicant: Samsung Display Co., Ltd., Yongin-City (KR)

(72) Inventors: Jang-Il KIM, Asan-si (KR); Sei-yong PARK, Suwon-si (KR); Sunghee HONG, Hwaseong-si (KR)

(21) Appl. No.: 14/456,968

(22) Filed: Aug. 11, 2014

(30) Foreign Application Priority Data
Feb. 11, 2014 (KR) 10-2014-0015659

(51) Int. Cl. G09G 3/36; B23K 26/00

(52) U.S. Cl. CPC G09G 3/3696; B23K 26/0003; G09G 2320/0673; G09G 2300/0426

(57) ABSTRACT

Provided is a display device. The display device includes a display panel including a division pattern including a lower division wiring disposed on a bottom substrate, an upper division wiring disposed on a top substrate, and a short connector and displaying images and a signal controller including a panel recognition unit generating panel data according to a division output signal outputted from the division pattern. As a result, the display device recognizes a location in the mother substrate assembly of the display panel, selects a gamma value according to the display cell symbol, and gamma-corrects image information, thereby improving gamma characteristics of the display device.

### CROSS-REFERENCE TO RELATED APPLICATIONS

This U.S. non-provisional patent application claims priority under 35 U.S.C. §119 to Korean Patent Application No. 10-2014-0015659, filed on Feb. 11, 2014, the entire contents of which are hereby incorporated by reference.

### BACKGROUND

The inventive concept disclosed herein relates to a display device, and more particularly, to a display device improving gamma characteristics.

Electronic apparatuses providing users with images, such as smart phones, digital, cameras, laptop computers, navigation devices, and smart televisions, include a display panel for displaying images. Generally, in a process of manufacturing the display panel, a plurality of display cells are formed in one mother substrate.

### SUMMARY

The present disclosure provides a display device improving in gamma characteristics.

Embodiments of the inventive concept provide display devices including a display panel including a division pattern, the division pattern including information corresponding to a location in a mother substrate assembly, and a signal controller including a panel recognition unit inputting a division input signal into the division pattern, receiving a division output signal corresponding to the location in the mother substrate assembly from the division pattern, and generating panel data according to the division output signal, and a gamma correction unit selecting a gamma value according to the location in the mother substrate assembly and correcting gamma of image information received from the outside based on the gamma value to generate an image data, the signal controller providing the display panel with the image data.

In some embodiments, the display panel may further include a bottom substrate and a top substrate opposite to the bottom substrate, the division pattern may include a lower division wiring disposed on the bottom substrate and including an input division wiring and an output division wiring, an upper division wiring disposed on the top substrate, and a short connector electrically connected to the lower division wiring and the upper division wiring according to the location in the mother substrate assembly, and the panel recognition unit may input the division input signal through the input division wiring and may receive the division output signal from the output division wiring.

In some embodiments, at least a part of the upper division wiring may overlap one end of the lower division wiring in a top view and the short connector may connect the one end of the lower division wiring and the upper division wiring.

In some embodiments, the short connector may include an input short connector connected to the input division wiring and the upper division wiring and an output short connector connected to the output division wiring and the upper division wiring.

In some embodiments, the lower division wiring and the short connector may include a plurality of the lower division wirings and a plurality of the short connectors, respectively.

In other embodiments, the upper division wiring may include a plurality of the upper division wirings, the plurality of the upper division wirings being spaced apart from one another and the short connectors may be connected to the lower division wirings and the upper division wirings according to the location in the mother substrate assembly

In further embodiments, the bottom substrate comprises at least one fanout portion receiving a data signal from a data driver and the division pattern is provided in a dead space in which the fanout portion is not formed.

In still further embodiments, the dead space may include first and second dead spaces located with the fanout portion intervening therein, the lower division wiring may include a first lower division wiring disposed in the first dead space and a second lower division wiring disposed in the second dead space, the upper division wiring may include a first upper division wiring disposed in the first dead space and a second upper division wiring disposed in the second dead space, and the short connector comprises a first short connector electrically connected to the first lower division wiring and the first upper division wiring according to the location in the mother substrate assembly and a second short connector electrically connected to the second lower division wiring and the second upper division wiring according to the location in the mother substrate assembly.

In even further embodiments, the display panel may include any one of an organic emission layer and a liquid crystal layer.

In other embodiments of the inventive concept, mother substrate assemblies includes 2m=N number of display cells and N number of mutually different division patterns comprising information corresponding to a location in the mother substrate assembly, the N number of mutually different division patterns being formed on each of the N number of display cells, in which each of the N number of mutually different division patterns comprises m number of lower division wirings.

In some embodiments, each of the N number of display cells may include at least one fanout portion configured to receive a data signal from a data driver and the division patterns may be provided in a dead space in which the fanout portion is not formed.

In other embodiments, each of the lower division wirings may include an input division wiring and an output division wiring.

In still other embodiments of the inventive concept, methods of manufacturing a display device includes forming 2m=N number of display cells on a mother substrate assembly, forming N number of division patterns comprising information corresponding to a location in the mother substrate assembly in each of the N number of display cells, respectively, forming N number of display panels from the N number of display cells by cutting the mother substrate assembly, and forming a signal controller on each of the display panels, the signal controller including a panel recognition unit connected to the division pattern of each of the display panels and generating panel data, the panel data including information about the location in the mother substrate assembly and a gamma correction unit selecting a gamma value according to the panel data and correcting gamma of an image information received from the outside based on the gamma value to generate an image data.

In some embodiments, the forming of the display cells may include forming a bottom substrate and a top substrate opposite to the bottom substrate and the forming of the division pattern may include forming a lower division wiring including an input division wiring and an output division wiring on the bottom substrate, forming an upper division wiring disposed on the top substrate, and selectively forming a short connecter electrically connecting the lower division wiring to the upper division wiring according to the location in the mother substrate assembly.

In other embodiments, the method may further include forming a short point electrically connecting the top substrate to the bottom substrate by interposing a conductive material between the top substrate and the bottom substrate, in which the forming the short connector and the forming of the short point may be performed at the same time.

In still other embodiments, the forming of the top substrate may include forming a base substrate and forming a common electrode on the base substrate and the forming of the upper division wiring and the forming of the common electrode may be performed at the same time.

In even other embodiments, the forming of the upper division wiring may be performed by removing a part of the common electrode through laser trimming

In yet other embodiments, the forming of the bottom substrate may include forming a thin film transistor comprising a gate electrode, a drain electrode, and a gate insulating film electrically insulating the gate electrode from the drain electrode, on a first base substrate, and forming a pixel electrode connected to the drain electrode of the thin film transistor.

In further embodiments, the forming of the lower division wiring and the thin film transistor may be performed at the same time.

In still further embodiments, the gate insulating film may cover at least a part of the lower division wiring and the forming of the short connector may include forming a contact hole by removing the gate insulating film and selectively forming the short connector in the contact hole.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a top view of a mother substrate assembly according to an embodiment of the inventive concept;

FIG. 2 is a block diagram of a display device according to an embodiment of the inventive concept;

FIG. 3 is a block diagram of a lookup table;

FIG. 4 is a cross-sectional view of a display panel according to an embodiment of the inventive concept;

FIG. 5 is a top view of the display device of FIG. 2;

FIG. 6 is an enlarged top view illustrating a panel recognition unit and a division pattern of FIG. 5;

FIG. 7 is an enlarged perspective view illustrating the division pattern shown in FIG. 6;

FIG. 8 is a cross-sectional view illustrating a part taken along a line I-I′ of FIG. 6;

FIG. 9 is a rear view of a top substrate of FIG. 6;

FIG. 10 is a top view of a display device according to another embodiment of the inventive concept;

FIG. 11 is an enlarged perspective view of a division pattern of the display device of FIG. 10; and

FIG. 12 is a rear view of a deck of FIG. 11.

### DETAILED DESCRIPTION OF THE EMBODIMENTS

Exemplary embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

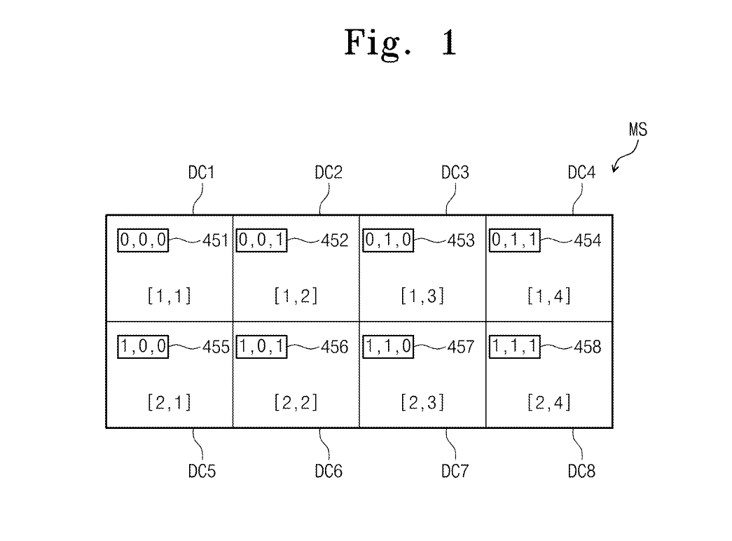

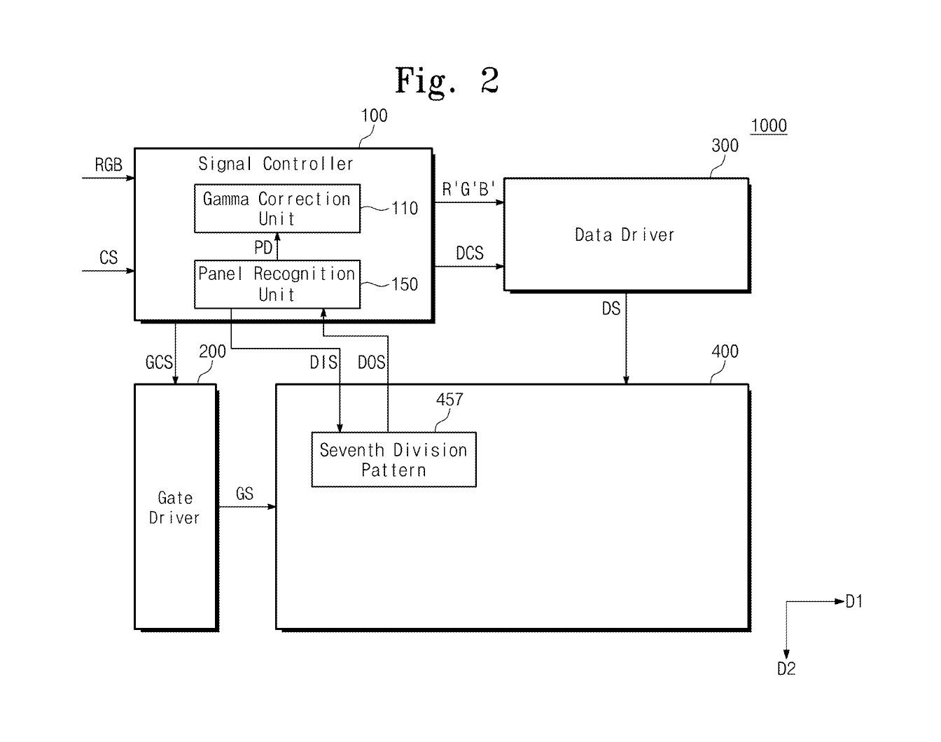

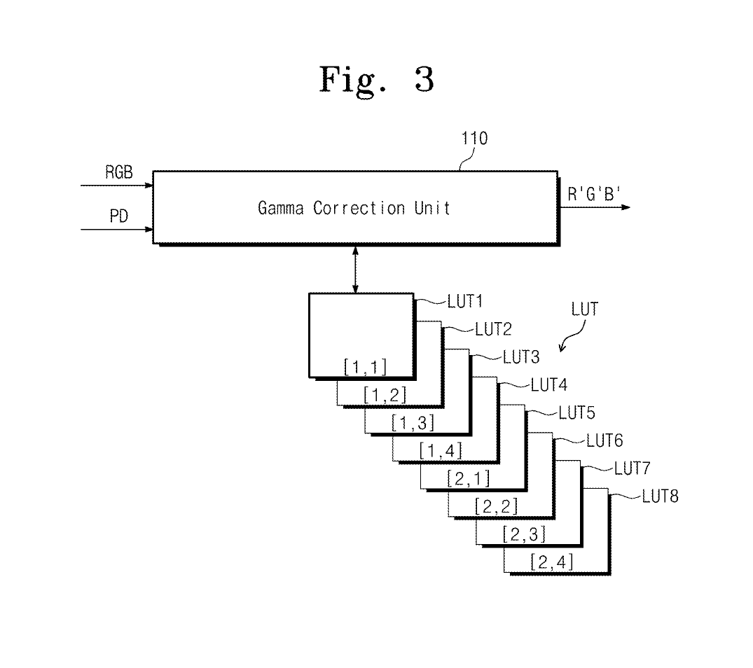

FIG. 1 is a top view of a mother substrate assembly MS according to an embodiment of the inventive concept. FIG. 2 is a block diagram of a display device 1000 according to an embodiment of the inventive concept. FIG. 3 is a block diagram of a lookup table.

Referring to FIGS. 1 to 3, the mother substrate assembly MS includes a plurality of display cells.

Through a panel manufacturing process including a line forming process, a thin film transistor forming process, and a liquid crystal forming process, the mother substrate assembly MS including the display cells are formed. In the embodiment, the display cells include first to eighth display cells DC1 to DC8.

The first to eighth display cells DC1 to DC8 which are formed on different locations in the mother substrate assembly MS are formed through the same panel manufacturing process. Display properties such as gamma characteristics of the display cells DC1 to DC8 may be different according to the respective locations in the mother substrate assembly MS.

In this case, the first to eighth display cells DC1 to DC8 which are formed in different locations of the mother substrate assembly MS may have different gamma properties, thus, different gamma-corrections are required for each of the first to eighth display cells DC1 to DC8. To distinguish the first to eighth display cells DC1 to DC8, display cell symbols may be used. The display cell symbols correspond to the first to eighth display cells DC1 to DC8, respectively. The display cell symbols may be not only numerals but also any symbols capable of distinguish the first to eighth display cells DC1 to DC8, such as characters and expressions.

In the embodiment, the display cell symbols are matrix symbols. The display cell symbols include [1,1] to [2,4] given corresponding to the locations of the display cells DC1 to DC8 in the mother substrate assembly MS. For example, [1,1] may be given to the first display cell DC1 and [1,2] may be given to the second display cell DC2. Similarly, [1,3], [1,4], [2,1], [2,2], [2,3], and [2,4] may be given to the third to eighth display cells DC3 to DC8, respectively.

The first to eighth display cells DC1 to DC8 include mutually different division patterns. The division patterns are formed corresponding to the display cell symbols to include information corresponding to the display cell symbols. The division patterns output the information corresponding to the display cell symbols as division output signals. For example, the division output signal may be three bit binary numbers. The division patterns include first to eighth division patterns 451 to 458 formed on the first to eighth display cells DC1 to DC8.

In more detail, the first division pattern 451 generates the division output signal having a value of (0,0,0) corresponding to division cell symbol [1,1] and the second division patter 452 generates the division output signal having a value of (0,0,1) corresponding to division cell symbol [1,2].

The third division pattern 453 generates the division output signal having a value of (0,1,0) corresponding to division cell symbol [1.3] and the fourth division patter 454 generates the division output signal having a value of (0,1,1) corresponding to division cell symbol [1.4].

The fifth division pattern 455 generates the division output signal having a value of (1,0,0) corresponding to division cell symbol [2.1] and the sixth division patter 456 generates the division output signal having a value of (1,0,1) corresponding to division cell symbol [2.2].

The seventh division pattern 457 generates the division output signal having a value of (1,1,0) corresponding to division cell symbol [2.3] and the eighth division patter 458 generates the division output signal having a value of (1,1,1) corresponding to division cell symbol [2.4].

The mother substrate assembly MS is cut along boundaries between the first to eighth display cells DC1 to DC8, thereby separating the first to eighth display cells DC1 to DC8 from one another to become respectively display panels. The display panels are assembled into a display device through an assembling operation.

As shown in FIG. 2, the display device 1000 includes a signal controller 100, a gate driver 200, a data driver 300, and a display panel 400.

The display panel 400 may be any one of the first to eighth display cells DC1 to DC8. A configuration and function of the first to eighth display cells DC1 to DC8 are identical except the first to eighth division patterns 451 to 458.

Accordingly, hereinafter, a case, in which the seventh display cell DC7 is the display panel 400, will be representatively described and descriptions for other display cells will be omitted.

The signal controller 100 receives image information RGB and a control signal CS from the outside. The signal controller 100 provides the gate driver 200 with a gate control signal GCS for controlling the gate driver 200 and provides the data driver 300 with a data control signal DCS for controlling the data driver 300 and image data R′G′B′.

The gate driver 200 receives the gate control signal GCS and provides the display panel 400 with a gate signal GS.

The data driver 300 receives the data control signal DCS and the image data R′G′B′ and provides the display panel 400 with a data signal DS.

The display panel 400 receives the gate signal GS and the data signal DS and display an image. The display panel 400 is not limited to a specific display panel. The display panel 400 may be one of an organic light emitting display panel, a liquid crystal display (LCD) panel, an electrophoretic display panel, and a plasma display panel.

The display panel 400 includes a plurality of gate lines, a plurality of data lines, a plurality of pixels, and the seventh division pattern 457. The plurality of gate lines extend in a first direction D1 and are electrically connected to the gate driver 200 and the plurality of pixels. The plurality of gate lines provide the plurality of pixels with the gate signals GS. The plurality of data lines extend in a second direction D2 vertical to the first direction D1 and are electrically connected to the data driver 300 and the plurality of pixels. The plurality of data lines provide the plurality of pixels with the data signals DS.

The plurality of pixels generate images corresponding to the gate signals GS and the data signals DS.

The signal controller 100 includes a gamma correction unit 110 and a panel recognition unit 150.

The panel recognition unit 150 generates panel data PD corresponding to the seventh division pattern 457. In more detail, the panel recognition unit 150 provides the seventh division pattern 457 with a division input signal DIS and receives a division output signal DOS having the value of (1,1,0) from the seventh division pattern 457. The panel recognition unit 150, in response to the division output signal DOS having the value of (1,1,0), generates the panel data PD and provides the gamma correction unit 110 with the panel data PD.

The gamma correction unit 100 receives the image information RGB and the panel data PD and outputs the image data R′G′B′. The gamma correction unit 110 selects a previously stored gamma value according to the panel data PD and outputs the image data R′G′B′ which are gamma-corrected image information according to the selected gamma value.

Referring to FIG. 3, the gamma correction unit 110 includes a lookup table LUT LUT1 to LUT8 storing gamma values corresponding to the location of the display cells DC1 to DC8. The gamma correction unit 110 corrects gamma of the image information RGB by referring to lookup tables LUT1 to LUT8 and generates the image data R′G′B′.

The lookup table LUT is provided as a plurality thereof In the embodiment, the lookup table LUT, for example, includes first to eighth lookup tables LUT1 to LUT8 corresponding to the display cells DC1 to DC8 in the mother substrate assembly MS. The first to eighth lookup tables LUT1 to LUT8 may store first to eighth preset gamma values, respectively.

The first to eighth gamma values, for example, correspond to the display cell symbols one by one. In more detail, the first gamma value corresponds to [1,1]. The first gamma value is preset to correct a gamma value of a display cell corresponding to [1,1]. The second gamma value corresponds to [1,2]. The second gamma value is preset to correct a gamma value of a display cell corresponding to [1.2]. Similarly, the third to eighth gamma values correspond to [1,3], [1,4], [2,1], [2,2], [2,3], and [2,4], respectively.

In the embodiment, the gamma correction unit 110 selects the seventh lookup table LUT7 corresponding to the panel data PD from the first to eighth lookup tables LUT1 to LUT8 and corrects gamma of the image information RGB by referring to the seventh lookup table LUT7 for the seventh gamma value.

Overall, the seventh division pattern 457 outputs the division output signal DOS having the value of (1,1,0) corresponding to display cell symbol [2,3] and the gamma correction unit 110 corrects gamma of the image information RGB by selecting the seventh lookup table LUT7 corresponding to display cell symbol [2,3] based on the panel data PD outputted from the panel recognition unit 150 in response to the division output signal DOS. That is, since the display device 1000 recognizes [2,3], which is the display cell symbol of the display panel 400, through the seventh pattern 457 and corrects gamma corresponding to the display cell symbol [2,3], gamma characteristics of the display device 1000 is improved.

Also, as described above, when the seventh division pattern 457 is connected to the signal controller 100, since the signal controller 100 corrects gamma referring to the seventh lookup table LUT7 corresponding to the seventh display cell

DC7, the gamma correction according to gamma characteristics of the seventh display cell DC7 is performed without an additional process. That is, it is not necessary to measure gamma characteristics of the display cells before correcting gamma to classify the first to eighth display cells DC1 to DC8 according to the measured gamma characteristics because the display panel 400 already has the information of the location in the mother substrate assembly MS.

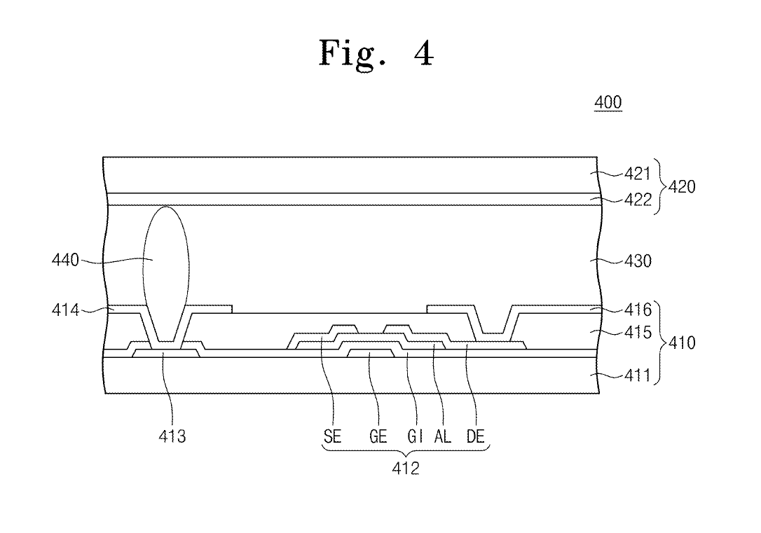

FIG. 4 is a cross-sectional view of the display panel 400.

Referring to FIG. 4, the display panel 400 includes a bottom substrate 410, a top substrate 420, a light control layer 430, and a short point 440.

The bottom substrate 410 includes a first base substrate 411, a thin film transistor 412, a common wiring 413, a contact portion 414, an organic insulating film 415, and a pixel electrode 416.

The thin film transistor 412 is turned on or off in response to the gate signal GS. When being tuned on, the thin film transistor 412 provides the pixel electrode 416 with the data signal DS. The thin film transistor 412 is electrically connected to a corresponding gate line among the plurality of gate lines, to a corresponding data line among the plurality of data lines, and to the pixel electrode 416.

The thin film transistor 412 includes a gate electrode GE, a gate insulating film GI, a semiconductor layer AL, a source electrode SE, and a drain electrode DE. The gate electrode GE is disposed on the first base substrate 411. The gate electrode GE and the semiconductor layer AL are insulated from each other by the gate insulating film GI. The semiconductor layer AL is disposed above the gate electrode GE with the gate insulating film GI intervening therebetween. The source electrode SE is disposed on the semiconductor layer AL to be in contact with the semiconductor layer AL. The drain electrode DE is disposed on the semiconductor layer AL to be spaced apart from the source electrode SE and to be in contact with the semiconductor layer AL.

The common wiring 413 receives a common voltage. The common wiring 413 is disposed on the first base substrate 411. The common wiring 413 may be formed through the same process as the gate electrode GE. In this case, the common wiring 413 is formed on the same plane as the gate electrode GE and is formed of the same material as the gate electrode GE. Also, not limited thereto, the common wiring 413 may be formed through the same process as the drain electrode DE and the source electrode SE. In this case, the common wiring 413 is formed on the same plane as the drain electrode DE and the source electrode SE and is formed of the same material as the drain electrode DE and the source electrode SE.

The organic insulating film 415 covers the common wiring 413 and the thin film transistor 412. The organic insulating film 415 is formed of an organic material having insulating properties. The pixel electrode 416 is electrically connected to the drain electrode DE exposed through a first contact hole formed by removing the organic insulating film 415. The pixel electrode 416, for example, may be formed of a transparent conductor such as indium tin oxide (ITO).

The contact portion 414 is electrically connected to the common wiring 413 exposed through a second contact hole formed by removing the organic insulating film 415 and the gate insulating film GI. The contact portion 414 may be formed through the same process as the pixel electrode 416. In this case, the contact portion 414 is formed on the same plane as the pixel electrode 416 and is formed of the same material as the pixel electrode 416.

The top substrate 420 includes a second base substrate 421 and a common electrode 422.

The common electrode 422, for example, may be disposed throughout the second base substrate 421 and may be formed of a transparent conductor such as ITO.

The short point 440 is formed between the common electrode 422 and the contact portion 414 and electrically connects the common electrode 422 to the contact portion 414. The short point 440 has conductivity and may be easily formed by dotting a certain position in the display panel 400 using a dispenser. The short point 440, for example, may be formed of a conductive material including a sealant and conductive particles.

The common electrode 422 receives the common voltage through the short point 440.

The light control layer 430 generates an image through an electric field formed between the common electrode 422 and the pixel electrode 416. The light control layer 430 may be any one of an organic emission layer, a liquid crystal layer, an electrophoretic layer, and a plasma emission layer.

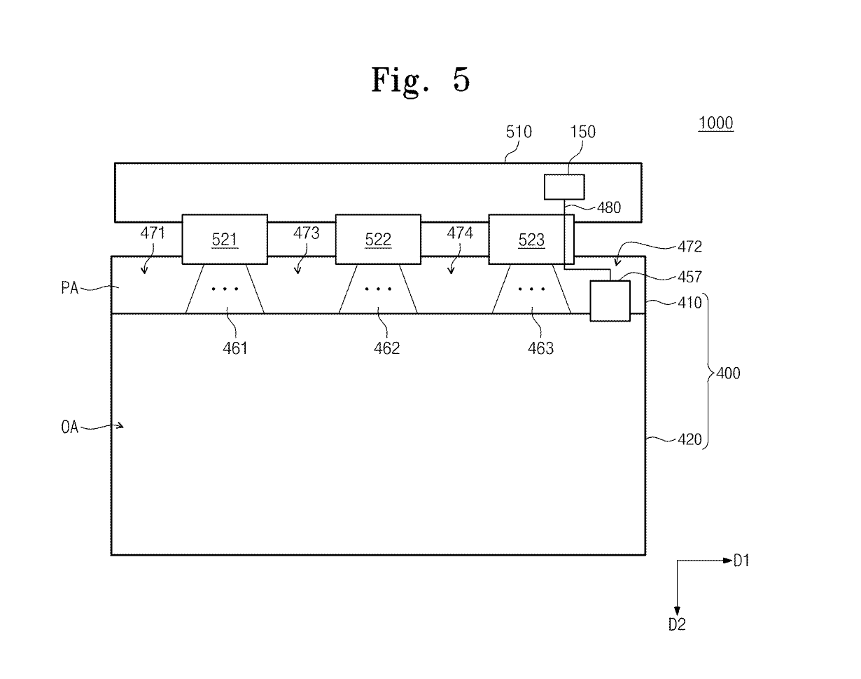

FIG. 5 is a top view of the display device 1000.

Referring to FIG. 5, the display device 1000 includes a printed circuit board (PCB) 510 and first to third driving circuit films 521 to 523. The panel recognition unit 150 may be formed in the PCB 510.

The first to third driving circuit films 521 to 523 electrically connect the PCB 510 to the display panel 400 and are disposed to be spaced apart from one another in the first direction D1. The first to third driving circuit films 521 to 523 may be mounted with the data driver 300. The display panel 400 includes a pad area PA, an overlap area OA, a dead space 471 to 474, and first to third fanout portions 461 to 463.

The overlap area OA, in a top view, is an area, in which the bottom substrate 410 and the top substrate 420 overlap each other. The pad area PA is an area, in which the bottom substrate 410 and the top substrate 420 do not overlap each other. Accordingly, a top surface of the bottom substrate 410 is exposed in the pad area PA.

The first to third fanout portions 461 to 463 are disposed to be spaced certain intervals apart in the first direction D1 and electrically connect the first to third driving circuit films 521 to 523 to the plurality of data lines. The first to third fanout portions 461 to 463 are connected to the first to third driving circuit films 521 to 523, respectively.

The dead space is a portion in which the first to third fanout portions 461 to 463 are not formed. The dead space includes first to fourth dead spaces 471 to 474. The first to fourth dead spaces 471 to 474 may overlap a part of the overlap area OA.

The first and second dead spaces 471 and 472 are located on both ends of the display panel 400. In more detail, the first dead space 471 is located on a left end of the display panel 400 adjacently to the first fanout portion 461 and the second dead space 472 is located on a right end of the display panel 400 adjacently to the third fanout portion 463.

The third and fourth dead spaces 473 and 474 are located between the first and third fanout portions 461 and 463. In more detail, the third dead space 473 is located between the first and second fanout portions 461 and 462 and the fourth dead space 474 is located between the second and third fanout portions 462 and 463.

In the embodiment, the seventh division pattern 457 is disposed in the second dead space 472. However, not limited thereto, the seventh division pattern 457 may be formed in various locations. For example, the seventh division pattern 457 may be disposed in any one of the first, third, and fourth dead spaces 471, 473, and 474.

The panel recognition unit 150, for example, may be disposed on the PCB 510 to be adjacent to the third driving circuit film 523.

The display device 1000 includes a connection wiring 480. The connection wiring 480 electrically connects the panel recognition unit 150 and the seventh division pattern 457 to each other through the third driving circuit film 523. According thereto, the panel recognition unit 150 applies the division input signal

DIS to the seventh division pattern 457 through the connection wiring 480. The seventh division pattern 457, in response to the division input signal DIS, generates the division output signal DOS and transmits the division output signal DOS to the panel recognition unit 150 through the connection wiring 480.

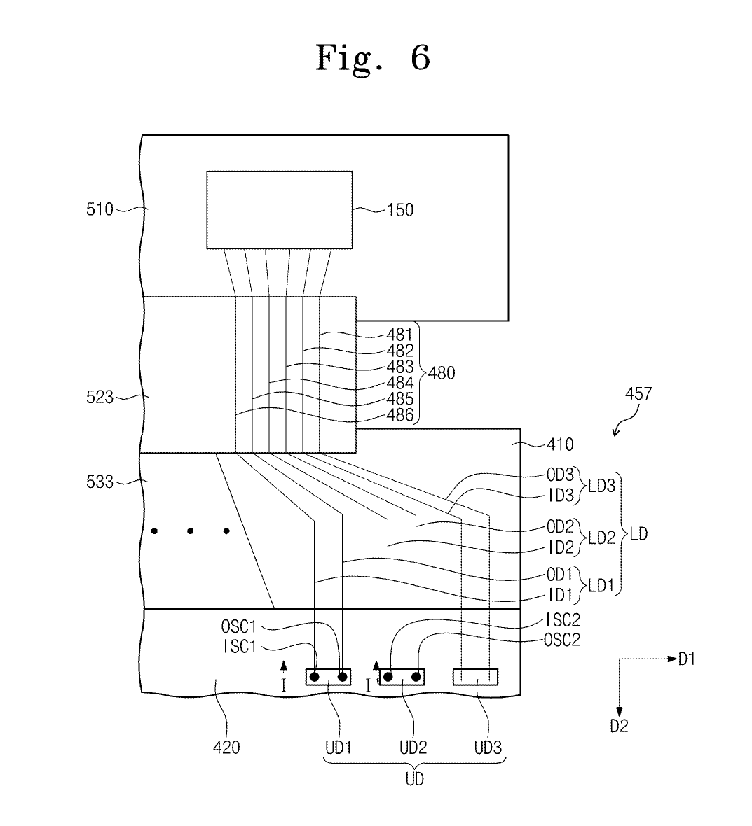

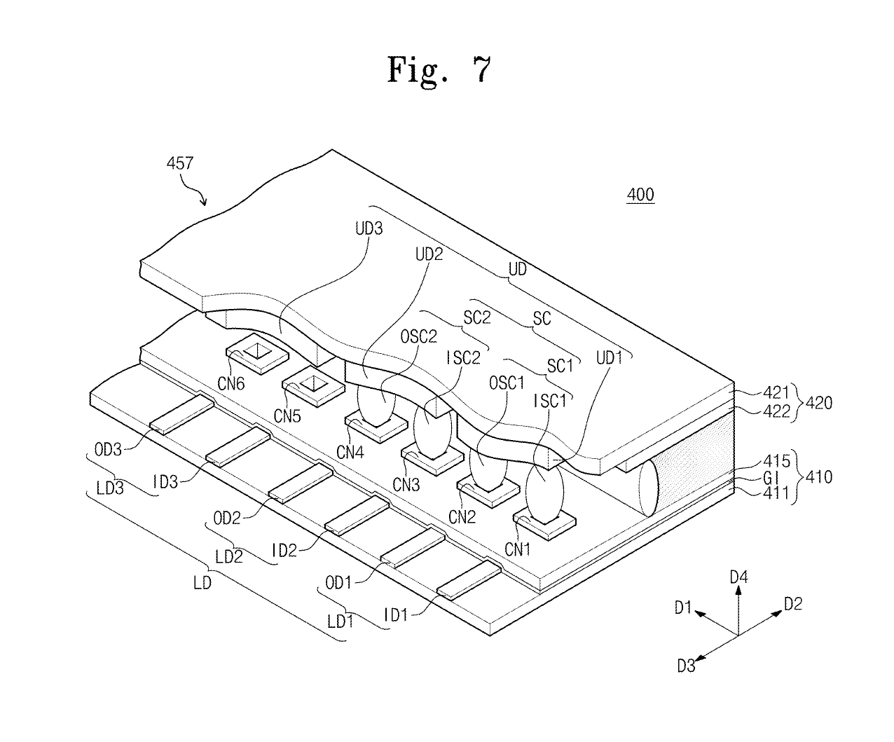

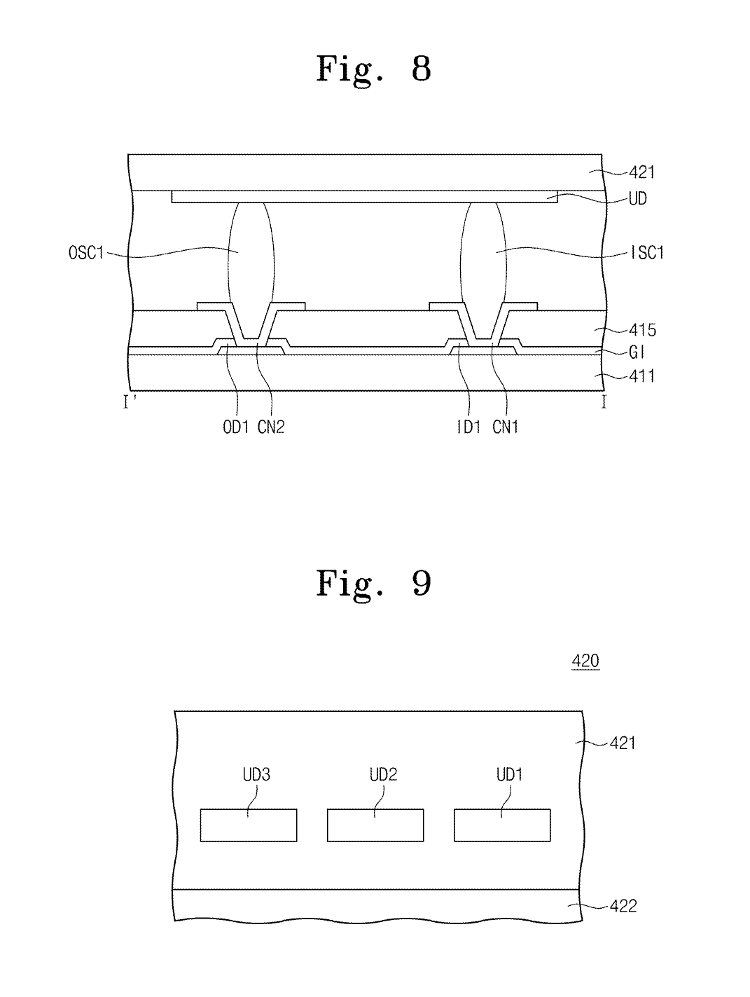

FIG. 6 is an enlarged top view illustrating the panel recognition unit 150 and the seventh division pattern 457. FIG. 7 is an enlarged perspective view illustrating the seventh pattern 457. FIG. 8 is a cross-sectional view illustrating a part taken along a line I-I′ of FIG. 6. FIG. 9 is a rear view of the top substrate 420.

Referring to FIGS. 6 to 9, the seventh division pattern 457 includes a lower division wiring LD including first to third lower division wirings LD1 to LD3, a short connector SC including first and second short connectors SC1 and SC2, and an upper division wiring UD including first to third upper division wirings UD1 to UD3.

The division input signals DIS includes first to third division input signals, and the division output signals DOS includes first to third division output signals.

The lower division wiring LD is disposed on the bottom substrate 410, the upper division wiring UD is disposed on the top substrate 420, and the short connector SC is disposed between the lower division wiring LD and the upper division wiring UD.

The lower division wiring LD may be formed through the same process as the thin film transistor 412. For example, the lower division wiring LD may be formed through the same process as the gate electrode GE. Accordingly, the lower division wiring LD is formed on the same plane as the gate electrode GE and is formed of the same material as the gate electrode GE. For example, not limited thereto, the lower division wiring LD may be formed through the same process as the drain electrode DE. Accordingly, the lower division wiring LD is formed on the same plane as the drain electrode DE and is formed of the same material as the drain electrode DE. As describe above, an additional process for forming the lower division wiring LD is not necessary.

The upper division wiring UD may be formed through the same process as the common electrode 422. In this case, the upper division wiring UD is formed on the same plane as the common electrode 422 and is formed of the same material as the common electrode 422. Accordingly, an additional process for forming the upper division wiring UD is not necessary.

Also, the upper division wiring UD may be formed by partially removing the common electrode 422 through laser trimming For example, the upper division wiring UD may be formed by removing the common electrode 422 around the upper division wiring UD. Thus, the upper division wiring UD may be electrically disconnected to the common electrode 422.

The short connector SC may be formed through the same process as the short point 440. Accordingly, the short connector SC may be formed in a certain position through dotting of the dispenser and an additional process for forming the short connector SC is not necessary. The short connector SC may be formed of a conductive material including a sealant and conductive particles, as the short point 440.

The short connector SC is selectively disposed according to the display cell symbol. In more detail, the short connector SC, according to display cell symbol [2,3] (shown in FIG. 1), is selectively formed, thereby selectively connecting the lower division wiring LD and the upper division wiring UD.

For example, the first short connector SC1 is formed between the first lower division wiring LD1 and the first upper division wiring UD1 and electrically connects the first lower division wiring LD1 to the first upper division wiring UD1. The second short connector SC2 is formed between the second lower division wiring LD2 and the second upper division wiring UD2 and electrically connects the second lower division wiring LD2 to the second upper division wiring UD2. However, since a short connector corresponding to the third lower division wiring LD3 and the third upper division wiring UD3 is not provided, the third lower division wiring LD3 is not connected to the third upper division wiring UD3.

The connection wiring 480 includes first to sixth connection wirings 481 to 486 disposed to be spaced apart from one another in the first direction D1. One ends of the first to sixth connection wirings 481 to 486 are electrically connected to the panel recognition unit 150 and other ends of the first to sixth connection wirings 481 to 486 extend in the second direction D2 and are connected to the respective first to third lower division wirings LD1 to LD3.

The first lower division wiring LD1 includes a first input division wiring ID 1 and a first output division wiring OD 1. The one ends of the first input and output wirings ID1 and OD1 are electrically connected to the first and second connection wirings 481 and 482, respectively.

The bottom substrate 410 includes first and second contact portions CN1 and CN2. The gate insulating film GI and the organic insulating film 415 covers the first to sixth connection wirings 481 to 486. The first and second contact portions CN1 and CN2 are electrically connected to other ends of the first input and output division wirings ID1 and OD1 exposed through contact holes formed by removing the gate insulating film GI and the organic insulating film 415.

The first short connector SC1 includes a first input short connector ISC1 and a first output short connector OSC1. A bottom end of the first input short connector ISC1 is electrically connected to the first input division wiring ID1 through the first contact portion CN1. A bottom end of the first output short connector OSC1 is electrically connected to the first output division wiring OD1 through the second contact portion CN2.

The first upper division wiring UD1 is disposed to allow at least a part to overlap the other ends of the first input and output division wirings ID1 and OD1 from a top view. The first upper division wiring UD1 is spaced apart from the common electrode 422 in a third direction D3 opposite to the second direction D2 to form an island pattern which is electrically disconnected to the common electrode 422.

The first input and output short connectors ISC1 and OSC1 extend from the first and second contact portions CN1 and CN2 in a fourth direction D4 vertical to the first direction and the second direction D2. Top ends of the first input and output short connectors ISC1 and OSC1 are electrically connected to the first upper division wiring UD1.

As a result, the first input and output wirings ID1 and OD1 are electrically connected through the first short connector SC1 and the first upper division wiring UD1 to be short-circuited.

The panel recognition unit 150 provides the first input wiring ID1 with the first division input signal. In this case, the first output wiring OD1 outputs the first division output signal having a short signal to the panel recognition unit 150 because the first input wiring ID1 and the first output wiring OD1 are short-circuited through the first short connector SC1 and the first upper division wiring UD1 .

Hereinafter, similar to the first lower division wiring LD 1, the first short connector SC1, and the first upper division wiring UD1, the second lower division wiring LD2, the second short connector SC2, and the second upper division wiring UD2 will be described.

The second lower division wiring LD2 includes a second input division wiring ID2 and a second output division wiring OD2. One ends of the second input and output wirings ID2 and OD2 are electrically connected to the third and fourth connection wirings 483 and 484, respectively.

The bottom substrate 410 includes third and fourth contact portions CN3 and CN4. The third and fourth contact portions CN3 and CN4 are electrically connected to other ends of the second input and output division wirings ID2 and OD2 exposed through contact holes formed by removing the gate insulating film GI and the organic insulating film 415.

The second short connector SC2 includes a second input short connector ISC2 and a second output short connector OSC2. A bottom end of the second input short connector ISC2 is electrically connected to the second input division wiring ID2 through the third contact portion CN3. A bottom end of the second output short connector OSC2 is electrically connected to the second output division wiring OD2 through the fourth contact portion CN4.

The second upper division wiring UD2 is disposed to allow at least a part to overlap the other ends of the second input and output division wirings ID2 and OD2 from a top view. The second upper division wiring UD2 is spaced apart from the common electrode 422 in the third direction D3 to form an island pattern which is electrically disconnected to the common electrode 422.

The second input and output short connectors ISC2 and OSC2 are formed to extend from the third and fourth contact portions CN3 and CN4 in the fourth direction D4. Top ends of the second input and output short connectors ISC2 and OSC2 are electrically connected to the second upper division wiring UD2.

As a result, the second input and output wirings ID2 and OD2 are electrically connected through the second short connector SC2 and the second upper division wiring UD2 to be short-circuited.

The panel recognition unit 150 provides the second input wiring ID2 with the second division input signal. In this case, the second output wiring OD2 outputs the second division output signal having a short signal to the panel recognition unit 150 because the second input wiring ID2 and the second output wiring OD2 are short-circuited through the second short connector SC2 and the second upper division wiring UD2.

Hereinafter, similar to the second lower division wiring LD2, the second short connector SC2, and the second upper division wiring UD2, the third lower division wiring LD3, the third short connector SC3, and the third upper division wiring UD3 will be described.

The third lower division wiring LD3 includes a third input division wiring ID3 and a third output division wiring OD3. One ends of the third input and output wirings ID3 and OD3 are electrically connected to the fifth and sixth connection wirings 485 and 486, respectively.

The bottom substrate 410 includes fifth and sixth contact portions CN5 and CN6. The fifth and sixth contact portions CN5 and CN6 are electrically connected to other ends of the third input and output division wirings ID3 and OD3 exposed through contact holes formed by removing the gate insulating film GI and the organic insulating film 415.

The third upper division wiring UD3 is disposed to allow at least a part to overlap the other ends of the third input and output division wirings ID3 and OD3 from a top view. The third upper division wiring UD3 is spaced apart from the common electrode 422 in the third direction D3 to form an island pattern which is electrically disconnected to the common electrode 422.

Between the fifth and sixth contact portions CN5 and CN6, a short connector is not disposed. As a result, the third input and output wirings ID3 and OD3 are not electrically connected, thereby being open-circuited.

The panel recognition unit 150 provides the third input wiring ID3 with the third division input signal. In this case, the third output wiring OD3 outputs the third division output signal having an open signal corresponding to the open state to the panel recognition unit 150.

Overall, the seventh division pattern 457 provides the first to third division output signals having the short signal and the open signal, respectively. Hereinafter, when the short signal is defined as “1” and the open signal is defined as “0”, the seventh division pattern 457 provides the panel recognition unit 150 with the division output signal DOS having the value of (1,1,0) corresponding to the display cell symbol of [2,3].

In other words, the seventh division pattern 457 includes the short connector SC selectively disposed according to the display cell symbol of [2,3] of the display panel, thereby generating the division output signal DOS having the value of (1,1,0) corresponding to display cell [2,3].

Also, since the short connector SC is formed by dotting through the dispenser, the disposition of the short connector SC may be easily modified. Accordingly, the first to eighth division patterns 451 to 458 may be differently formed from one another without a change in mask. In more detail, the lower division wiring LD and the upper division wiring UD are formed as the same pattern and only the disposition of the short connector SC is changed through the dispenser, thereby easily forming the mutually different first to eighth division patterns 451 to 458.

In the above, the seventh division pattern 457 includes the first to third lower division wirings LD1 to LD3 and the division output signal DOS includes the first to third division output signals.

However, not limited thereto, the seventh division pattern 457 may include more than three lower division wirings. For example, the seventh division pattern 457 may include m number of lower division wirings. In this case, 2^{m}=N kinds of mutually different division patterns may be formed and N number of mutually division output signals may be generated. As a result, N number of display panels in the mother substrate assembly may be recognized. The number of lower division wirings may be decided according to the number of the display cells in the mother substrate assembly.

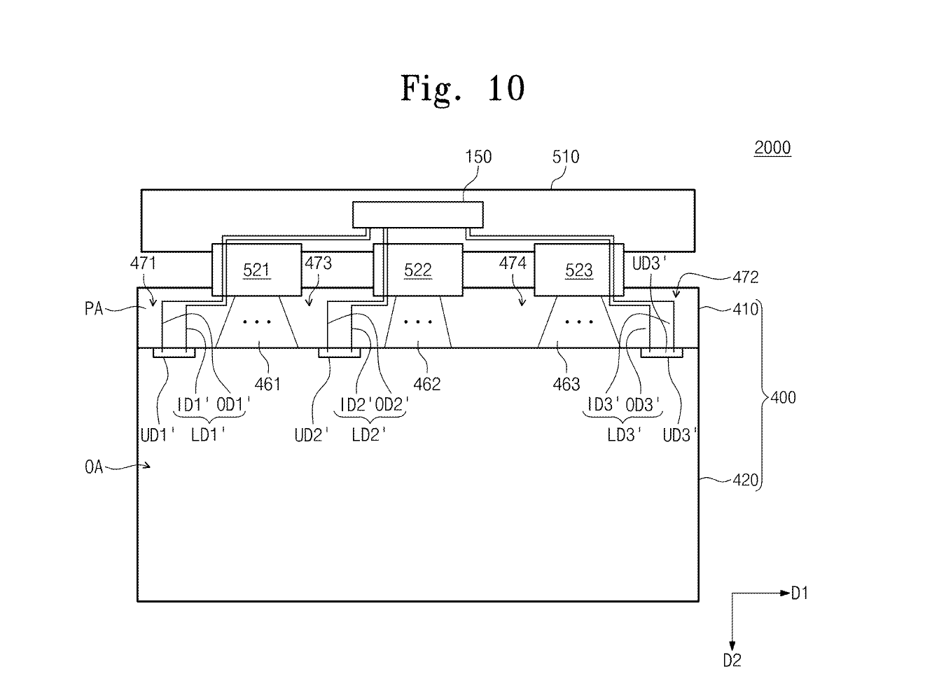

FIG. 10 is a top view of a display device 2000 according to another embodiment of the inventive concept. Since elements having the same reference numerals shown in FIGS. 6 to 9 are similar to elements referred to as corresponding reference numerals, a repetitive description thereof will be omitted.

Referring to FIG. 10, the display device 2000 includes a division pattern including first to third lower division wirings LD1′ to LD3′ and first to third upper division wirings UD1′ to UD3′.

Since the first to third lower division wirings LD1′ to LD3′ and the first to third upper division wirings UD1′ to UD3′ differ from the first to third lower division wirings LD1 to LD3 and the first to third upper division wirings UD1 to UD3 only in location in the display panel 400, only the location of the first to third lower division wirings LD1′ to LD3′ and the first to third upper division wirings

UD1′ to UD3′ will be described with reference to FIG. 10.

The first upper division wiring UD1′ is disposed on the top substrate 420 corresponding to the first dead space 471.

The first lower division wiring LD1′ is disposed in the first dead space 471 and includes a first input division wiring ID1′ and a first output division wiring OD1′. One ends of the first input division wiring ID1′ and the first output division wiring OD1′ are electrically connected to the panel recognition unit 150 through the first driving circuit film 521. Other ends of the first input division wiring ID1′ and the first output division wiring OD1′ extend to overlap the first upper division wiring UD1′ in a top view.

The first upper division wiring UD1′ and the first input division wiring ID1′ are electrically connected to each other by a first input short connector intervening between the first upper division wiring UD1′ and the first input division wiring ID F. The first upper division wiring UD1′ and the first output division wiring OD 1′ are electrically connected to each other by a first output short connector intervening between the first upper division wiring UD1′ and the first output division wiring OD1′.

As a result, the first input and output wirings ID1′ and OD1′ are electrically connected through the first short connector and the first upper division wiring UD1′ to be short-circuited.

The panel recognition unit 150 provides the first input wiring ID1′ with the first division input signal. In this case, the first output wiring OD1′ outputs the first division output signal having a short signal to the panel recognition unit 150 because the first input division wiring ID1′ and the first output division wiring OD1′ are short-circuited.

The second upper division wiring UD2′ is disposed on the top substrate 420 corresponding to the third dead space 473.

The second lower division wiring LD2′ is disposed in the third dead space 473 and includes a second input division wiring ID2′ and a second output division wiring OD2′. One ends of the second input division wiring ID2′ and the second output division wiring OD2′ are electrically connected to the panel recognition unit 150 through the second driving circuit film 522. Other ends of the second input division wiring ID2′ and the second output division wiring OD2′ extend to overlap the second upper division wiring UD2′ in a top view.

The second upper division wiring UD2′ and the second input division wiring ID2′ are electrically connected to each other by a second input short connector intervening between the second upper division wiring UD2′ and the second input division wiring ID2′. The second upper division wiring UD2′ and the second output division wiring OD2′ are electrically connected to each other by a second output short connector intervening between the second upper division wiring UD2′ and the second output division wiring OD2′.

As a result, the second input and output wirings ID2′ and OD2′ are electrically connected through the second short connector and the second upper division wiring UD2′ to be short-circuited.

The panel recognition unit 150 provides the second input wiring ID2′ with the second division input signal. In this case, the second output wiring OD2′ outputs the second division output signal having a short signal to the panel recognition unit 150 because the second input division wiring ID2′ and the second output division wiring OD2′ are short-circuited.

The third upper division wiring UD3′ is disposed on the top substrate 420 corresponding to the second dead space 472.

The third lower division wiring LD3′ is disposed in the second dead space 472 and includes a third input division wiring ID3′ and a third output division wiring OD3′. One ends of the third input division wiring ID3′ and the third output division wiring OD3′ are electrically connected to the panel recognition unit 150 through the third driving circuit film 523. Other ends of the third input division wiring ID3′ and the third output division wiring OD3′ extend to overlap the third upper division wiring UD3′ in a top view.

Between the third upper division wiring UD3′ and the third input division wiring ID3′, a short connector corresponding thereto is not disposed. As a result, the third input and output wirings ID3′ and OD3′ are not electrically connected, thereby being open-circuited.

Overall, the division pattern provides the panel recognition unit 150 with the division output signal DOS having the value of (1,1,0) corresponding to the display cell symbol of [2,3].

As described above, since the division pattern includes the first to third lower division wirings LD1′ to LD3′ spatially divided and the first to third upper division wirings UD1′ to UD3′ spatially divided, although the first to fourth dead spaces 471 to 474 are formed to be narrow, the division pattern may be spatially divided and may be easily disposed in the dead spaces 471 to 474.

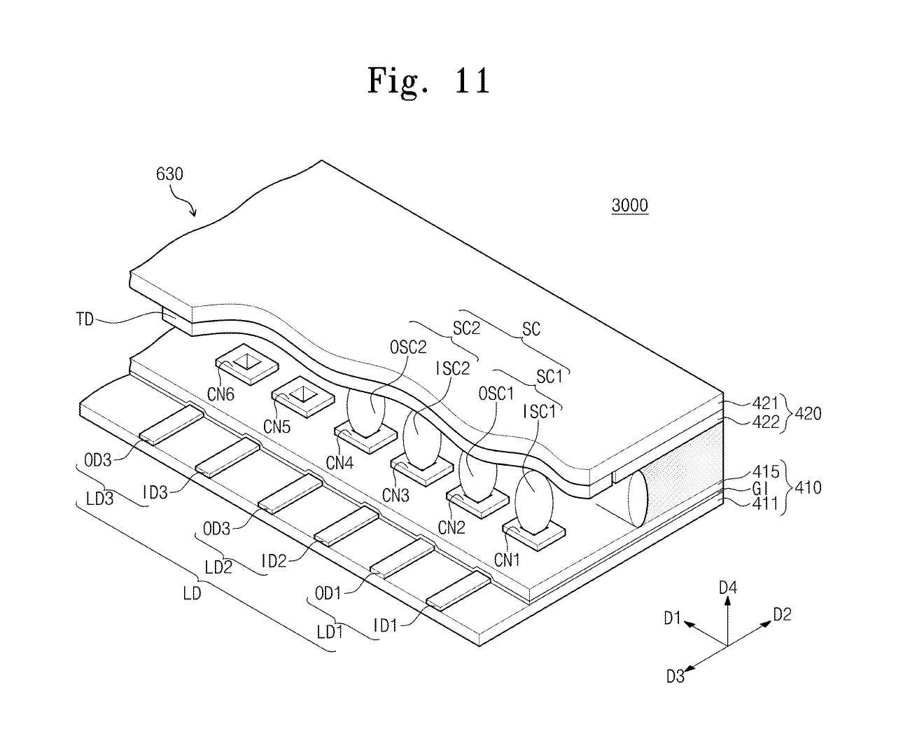

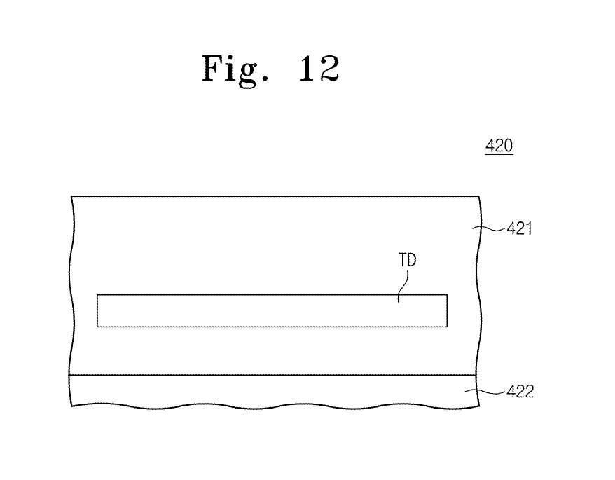

FIG. 11 is an enlarged perspective view of a division pattern 630 of a display device 3000 according to still another embodiment of the inventive concept. FIG. 12 is a rear view of the top substrate 420 of FIG. 11. Since elements having the same reference numerals shown in FIGS. 2 to 9 are similar to elements referred to as corresponding reference numerals, a repetitive description thereof will be omitted.

Referring to FIGS. 11 and 12, the display device 3000 includes the division pattern 630 including an upper division wiring TD.

The upper division wiring TD is disposed on the top substrate 420 to allow at least a part to overlap other ends of the first to third input division wirings ID1 to ID3 and the first to third output division wirings OD1 to OD3 in a top view. The upper division wiring TD is spaced apart from the common electrode 422 in the third direction D3 to form an island pattern which is electrically disconnected to the common electrode 422.

In the embodiment, the top end of the first input short connector ISC1 and the top end of the first output short connector OSC1 are electrically connected to the upper division wiring TD. According thereto, the first input and output wirings ID1 and OD1 are short-circuited through the first short connector SC1 and the upper division wiring TD. Also, the top end of the second input short connector ISC2 and the top end of the second output short connector OSC2 are electrically connected to the upper division wiring TD. According thereto, the second input and output wirings ID2 and OD2 are short-circuited through the second short connector SC2 and the upper division wiring TD. However, between the third lower division wiring and the upper division wiring TD, a short connector corresponding thereto is not provided. According thereto, the third input and output wirings ID3 and OD3 are in an open state.

According to the embodiments, a display device distinguishes and recognizes a display cell symbol of a display panel through a division pattern, selects a gamma value corresponding to the display cell symbol based on panel data generated based on a division output signal, and gamma-corrects image information. Accordingly, the display device may correct gamma of the image information according to gamma characteristics of the display panel without and additional process, thereby improving gamma characteristics of the display device.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A display device comprising:
a display panel comprising a division pattern, the division pattern comprising information corresponding to a location in a mother substrate assembly; and
a signal controller comprising:
a panel recognition unit inputting a division input signal into the division pattern, receiving a division output signal corresponding to the location in the mother substrate assembly from the division pattern, and generating panel data according to the division output signal, and
a gamma correction unit selecting a gamma value according to the location in the mother substrate assembly and correcting gamma of an image information received from the outside based on the gamma value to generate an image data, the signal controller providing the display panel with the image data.

2. The display device of claim 1,
wherein the display panel further comprises a bottom substrate and a top substrate opposite to the bottom substrate,
wherein the division pattern comprises:
a lower division wiring disposed on the bottom substrate and comprising an input division wiring and an output division wiring,
an upper division wiring disposed on the top substrate, and
a short connector electrically connected to the lower division wiring and the upper division wiring according to the location in the mother substrate assembly, and
wherein the panel recognition unit inputs the division input signal through the input division wiring and receives the division output signal from the output division wiring.

3. The display device of claim 2,
wherein at least a part of the upper division wiring overlaps one end of the lower division wiring in a top view, and
wherein the short connector connects the one end of the lower division wiring and the upper division wiring.

4. The display device of claim 2, wherein the short connector comprises an input short connector connected to the input division wiring and the upper division wiring and an output short connector connected to the output division wiring and the upper division wiring.

5. The display device of claim 2, wherein the lower division wiring and the short connector include a plurality of the lower division wirings and a plurality of the short connectors, respectively.

6. The display device of claim 5,
wherein the upper division wiring includes a plurality of the upper division wirings, the plurality of the upper division wirings being spaced apart from one another, and
wherein the short connectors are connected to the lower division wirings and the upper division wirings according to the location in the mother substrate assembly.

7. The display device of claim 2,
wherein the bottom substrate comprises at least one fanout portion receiving a data signal from a data driver, and
wherein the division pattern is provided in a dead space in which the fanout portion is not formed.

8. The display device of claim 7,
wherein the dead space comprises first and second dead spaces located with the fanout portion intervening therein,
wherein the lower division wiring comprises a first lower division wiring disposed in the first dead space and a second lower division wiring disposed in the second dead space,
wherein the upper division wiring comprises a first upper division wiring disposed in the first dead space and a second upper division wiring disposed in the second dead space, and
wherein the short connector comprises a first short connector electrically connected to the first lower division wiring and the first upper division wiring according to the location in the mother substrate assembly and a second short connector electrically connected to the second lower division wiring and the second upper division wiring according to the location in the mother substrate assembly.

9. The display device of claim 1, wherein the display panel comprises at least one of an organic emission layer and a liquid crystal layer.

10. A mother substrate assembly comprising:
2^{m}=N number of display cells; and
N number of mutually different division patterns comprising information corresponding to a location in the mother substrate assembly, the N number of mutually different division patterns being formed on each of the N number of display cells,
wherein each of the N number of mutually different division patterns comprises m number of lower division wirings.

11. The mother substrate assembly of claim 10,
wherein each of the N number of display cells comprises at least one fanout portion configured to receive a data signal from a data driver, and
wherein the division patterns are provided in a dead space in which the fanout portion is not formed. 15

12. The mother substrate assembly of claim 11, wherein each of the lower division wirings comprises an input division wiring and an output division wiring.

13. A method of manufacturing a display device, comprising:
forming 2^{m}=N number of display cells on a mother substrate assembly;
forming N number of division patterns comprising information corresponding to a location in the mother substrate assembly in each of the N number of display cells, respectively;
forming N number of display panels from the N number of display cells by cutting the mother substrate assembly; and
forming a signal controller on each of the display panels, the signal controller comprising:
a panel recognition unit connected to the division pattern of each of the display panels and generating panel data, the panel data including information about the location in the mother substrate assembly, and
a gamma correction unit selecting a gamma value according to the panel data and correcting gamma of image information received from the outside based on the gamma value to generate an image data.

14. The method of claim 13,
wherein the forming of the display cells comprises forming a bottom substrate and a top substrate opposite to the bottom substrate, and
wherein the forming of the division pattern comprises:
forming a lower division wiring comprising an input division wiring and an output division wiring on the bottom substrate,
forming an upper division wiring disposed on the top substrate, and
selectively forming a short connecter electrically connecting the lower division wiring to the upper division wiring according to the location in the mother substrate assembly.

15. The method of claim 14, further comprising forming a short point electrically connecting the top substrate to the bottom substrate by interposing a conductive material between the top substrate and the bottom substrate,
wherein the forming the short connector and the forming of the short point are performed at the same time.

16. The method of claim 15,
wherein the forming of the top substrate comprises forming a base substrate and forming a common electrode on the base substrate, and
wherein the forming of the upper division wiring and the forming of the common electrode are performed at the same time.

17. The method of claim 15, wherein the forming of the upper division wiring is performed by removing a part of the common electrode through laser trimming

18. The method of claim 14, wherein the forming of the bottom substrate comprises:
forming a thin film transistor comprising a gate electrode, a drain electrode, and a gate insulating film electrically insulating the gate electrode from the drain electrode, on a first base substrate, and
forming a pixel electrode connected to the drain electrode of the thin film transistor.

19. The method of claim 18, wherein the forming of the lower division wiring and the thin film transistor are performed at the same time.

20. The method of claim 19,
wherein the gate insulating film covers at least a part of the lower division wiring, and
wherein the forming of the short connector comprises forming a contact hole by removing the gate insulating film and selectively forming the short connector in the contact hole.
